(19) United States
(12) Patent Application Publication
(10) Pub. No.: US 2025/0332743 A1
(43) Pub. Date: Oct. 30, 2025

(54) SUCTION GRIPPER HAVING A LIFTING PISTON AND AN AUTOMATICALLY CLOSING VALVE APPARATUS

(71) Applicant: J.Schmalz GmbH, Glatten (DE)

(72) Inventor: Ralf Stockburger, Glatten (DE)

(73) Assignee: J.Schmalz GmbH, Glatten (DE)

(21) Appl. No.: 19/192,548

(22) Filed: Apr. 29, 2025

(30) Foreign Application Priority Data
Apr. 30, 2024 (EP) 24 173 414.4

(51) Int. Cl. B25J 15/06

(52) U.S. Cl. CPC B25J 15/0683

(57) ABSTRACT

A suction gripper comprising a gripper base body, a vacuum connection and at least one gripping unit comprising a lifting piston and a suction device, wherein the suction device can be supplied with vacuum through the lifting piston, wherein the lifting piston is adjustable along a lifting axis between an axially retracted passive configuration and an axially extended active configuration, wherein the gripping unit has a shut-off device for blocking and releasing a flow path between the vacuum connection and the suction device, wherein the gripping unit has at least one valve apparatus which is arranged in a flow path between the at least one suction point and the vacuum connection and which is designed to close automatically in the event of free suction with unoccupied at least one suction point and to block the flow path between the at least one suction point and the vacuum connection.

The invention relates to a suction gripper comprising a gripper base body and at least one gripping unit mounted thereon, having a lifting piston and a suction device which is motion-coupled to the lifting piston. The invention also relates to a gripping module having a plurality of such suction grippers.

Such suction grippers are known from the prior art. The lifting pistons are typically adjustable relative to the gripper base body between an axially retracted passive configuration and an axially extended active configuration, wherein in the passive configuration, the vacuum supply to the suction device is blocked and in the active configuration, it is released. In this respect, the suction device can be activated by extending the lifting piston.

With such suction grippers, it is possible to flexibly adapt the suction gripper to different geometries of the objects to be gripped by selectively extending individual suction units. Because the suction unit is extended in the active configuration relative to the passive configuration, the passive suction grippers do not form an interference contour when gripping an object.

The invention relates to the object of improving suction grippers of the type mentioned above. In particular, objects with irregular shapes and/or different sizes should be able to be gripped reliably and energy-efficiently in a structurally simple manner.

This object is achieved according to the invention by a suction gripper having the features of claim 1. The suction gripper is designed for suctioning and handling an object, in particular a flat material, more particularly a sheet metal component. The suction gripper is a suction gripping apparatus.

The suction gripper comprises a gripper base body, a vacuum connection for connection to a vacuum supply, in particular an external vacuum supply, and at least one gripping unit, preferably a plurality of gripping units, mounted on the gripper base body. The vacuum connection is preferably provided on the gripper base body. The gripper base body may also comprise a vacuum distribution system for distributing vacuum from the vacuum connection to the at least one gripping unit.

The gripping unit (or each gripping unit in the case of a plurality of gripping units) comprises a lifting piston and a suction device which is motion-coupled to the lifting piston, in particular mounted on the lifting piston, for suctioning and thus gripping an object. The lifting piston is adjustable, in particular by compressed air, along a lifting axis between an axially retracted passive configuration and an axially extended active configuration relative to the gripper base body. In particular, the lifting piston is adjustable relative to the gripper base body in an extension direction and in a retraction direction opposite to the extension direction. The retracted configuration and the extended configuration of the lifting piston form, in particular, end positions of a displacement path of the lifting piston along the lifting axis.

The suction device has at least one suction point for suctioning an object to be gripped. The suction device can be supplied with vacuum through the lifting piston. In particular, the lifting piston has a vacuum channel via which the suction device can be supplied with vacuum. Preferably, the vacuum channel opens at the free end of the lifting piston.

The gripping unit has a shut-off device for blocking and releasing a flow path between the vacuum connection and the suction device. The shut-off device can assume a blocking configuration in which the flow path between the vacuum connection and the suction device is blocked, and a release configuration in which the flow path is released. The shut-off device is designed such that it assumes the blocking configuration (i.e., blocks the flow path) in the passive configuration of the lifting piston and assumes the release configuration (i.e., releases the flow path) in the active configuration of the lifting piston. In particular, the shut-off device is designed such that it is transferred from the passive configuration to the active configuration to the release configuration by extending the lifting piston. The shut-off device can be designed such that in the passive configuration, it blocks a flow connection between the vacuum connection and the vacuum channel of the lifting piston and in the active configuration, it releases this flow connection. The shut-off device can be provided, for example, by a sealing device which is motion-coupled to the lifting piston and is arranged in particular at an end of the lifting piston opposite the suction device, which, in the passive configuration, seals a vacuum supply opening for supplying the vacuum channel provided in the lifting piston and, in the active configuration, releases the vacuum supply opening.

According to the invention, in addition to the shut-off device, the gripping unit has at least one valve apparatus which is different from the shut-off device and which is arranged in the flow path between the at least one suction point, in particular the suction device, and the vacuum connection. Preferably, the valve apparatus is arranged upstream of the shut-off device with respect to a suction flow from the at least one suction point to the vacuum connection. The at least one valve apparatus is designed to close automatically, in particular by the resulting suction air flow, in the event of free suction with unoccupied at least one suction point (i.e., with the lifting piston in the active configuration/shut-off device in the release configuration and without an object being suctioned into the at least one suction point), and thus to delimit or limit the flow path between the at least one suction point and the vacuum connection. In the present context, “delimiting” may comprise completely blocking the flow path or at least partially blocking the flow path. In this respect, “closing” the valve apparatus does not necessarily mean completely preventing the suction flow, but optionally also comprises reducing the suction flow compared to free suctioning. The valve apparatus is in particular designed to open automatically when at least one suction point is occupied (i.e., when an object is suctioned onto the at least one suction point) and thus to release the flow path between the suction device and the vacuum connection.

Such a design with an automatically closing valve apparatus makes it possible to close activated but unoccupied suction points in a structurally simple manner and thus to reduce leakage. This is particularly advantageous when gripping irregularly shaped objects and/or objects with a plurality of recesses. With such objects, due to the usually fixed arrangement of suction points, it may happen that one or more suction points do not meet the object or do not meet the object correctly (e.g., because they are arranged over a recess in the object). These suction points can then be automatically closed via the valve apparatus or at least the suction flow can be reduced, which promotes energy-efficient operation of the suction gripper. The proposed design also allows objects with comparatively small dimensions to be gripped safely and energy-efficiently.

In an advantageous further development, the valve apparatus can be designed such that it closes automatically even if the at least one suction point is partially (but not completely) occupied. In particular, the suction device provides a suction cross section, in particular a suction surface, wherein the valve apparatus is designed such that it closes automatically even if the suction cross section, in particular a suction surface, is only partially free. In this respect, the risk of an object not being reliably gripped can be reduced.

The at least one valve apparatus can be arranged at different positions along the flow path from the at least one suction point to the vacuum connection. Preferably, the at least one valve apparatus is arranged in a flow path between the at least one suction point, in particular the suction device, and the lifting piston. In this respect, the at least one valve apparatus is preferably arranged upstream of the shut-off device with respect to a suction flow from the at least one suction point to the vacuum connection. Such a configuration in the vicinity of the at least one suction point promotes fast and reliable switching of the valve apparatus.

In an advantageous further development, the suction device has a plurality of suction points, which are in particular fluidly connected in parallel. In particular, the suction device has a plurality of suction bodies, for example elastomer suction bodies, each of which provides a suction point. The suction bodies of a suction device can be designed differently, in particular they can provide a suction cross section of different sizes. It is also conceivable for the suction bodies of a respective suction device to be designed identically to one another. If multiple gripping units are provided, the gripping units can have different and/or differently sized suction bodies.

In an embodiment with a plurality of suction points, in particular suction bodies, a subset of the suction points, in particular suction bodies, preferably all suction points, in particular all suction bodies, of a corresponding suction device can be assigned a common valve apparatus. In this respect, the suction points of the suction device can be closed together by a valve apparatus during free suction. Such a design is structurally simple and compact. In particular, the suction points, in particular suction bodies, of a suction device can be connected in series with the same valve apparatus.

Alternatively, it is conceivable for each suction point, in particular each suction body, of a suction device to be assigned its own valve apparatus. This makes it possible to selectively switch off activated but unoccupied suction points of the suction device. This is advantageous, for example, when gripping objects with recesses, such as sheet metal components with larger through-holes, where it may happen that only a subset of the suction points of a suction device actually suction the object. Furthermore, such a design also allows reliable and energy-efficient gripping of delicate components which, for example, only occupy a subset of the suction bodies provided on the suction device.

In an advantageous further development, the suction device has a housing which is mounted on the lifting piston. Preferably, the housing has a suction device receiving space for the at least one suction body on a side facing away from the lifting piston. The at least one suction body can in particular be received in the suction device receiving space such that the suction body (in an initial configuration in which no object is suctioned) projects axially along the lifting axis with a contact surface for contact with an object to be gripped beyond a wall of the housing delimiting the receiving space. The wall of the housing can form a contact surface for the object to be gripped.

Preferably, the housing also has a valve receiving space, in particular arranged between the suction device receiving space and the lifting piston, in which the at least one valve apparatus is arranged. The at least one valve apparatus is thus protected from environmental influences. Furthermore, it is conceivable for the housing to delimit a flow channel between the at least one suction body and the at least one valve apparatus.

The valve apparatus can be designed in different ways. For example, the valve apparatus may have a valve housing which delimits a valve interior. A sealing portion and at least one sealing seat are preferably arranged in the valve interior. The sealing portion and the sealing seat are designed such that when the sealing portion is in contact with the sealing seat, the flow path of the at least one suction point assigned to the valve apparatus and the vacuum connection is interrupted. The sealing portion is designed such that, in particular, it can be displaced within the valve housing such that, during free suction with unoccupied at least one suction point, it is pressed against the sealing seat by the suction air flow and thus guided into contact with the sealing seat (closed position of the valve apparatus). The sealing portion can therefore assume a closed position in which the sealing portion rests against the sealing seat. The sealing portion can preferably assume a release position in which the sealing portion is spaced apart from the sealing seat, so that the flow path between the at least one suction point and the vacuum connection is released. The sealing portion can be provided by a valve body which is displaceable in the valve housing between the release position and the closed position. The sealing portion can also be provided by a portion of a flexibly deformable wall or membrane.

In a particularly advantageous embodiment, the valve apparatus can have a valve housing which defines a valve interior. The valve housing has, in particular on a first side facing the lifting piston, a vacuum opening which is in flow connection with the vacuum connection, in particular with a vacuum channel of the lifting piston. The vacuum opening opens into the valve interior. The valve housing also has, in particular on an opposite second end face facing the suction device, a suction opening which is in flow connection with the at least one suction point assigned to the valve apparatus, in particular the suction device. The suction opening opens into the valve interior.

The valve apparatus also has a flexible partition wall or membrane which extends in the valve interior such that, on the one hand, the flexible partition wall defines a control chamber in the valve interior and, on the other hand, the flexible partition wall defines a suction chamber. In particular, the partition wall divides the valve interior into a control chamber and a suction chamber. The control chamber is connected to the vacuum inlet. The suction chamber is connected to the suction opening.

The flexible partition wall has a throttle passage such that a flow path is provided from the suction opening or the suction chamber through the throttle passage into the control chamber and further from the control chamber through the vacuum opening. In particular, the flow path extends through the control chamber.

The throttle passage is designed such that a flow resistance for flows through the throttle passage is defined such that, in the case of free suction with unoccupied at least one suction point, a vacuum is formed in the control chamber compared to the suction chamber due to the flow resistance through the throttle passage.

The flexible partition wall is designed such that it deforms due to the vacuum that is formed in the control chamber during free suction, such that the volume of the control chamber is reduced under the influence of the vacuum. In the present context, free suction means that suction takes place when the at least one suction point of the suction device is unoccupied. A flow then occurs along the flow path from the suction device through the suction opening, the suction chamber, the throttle passage, the control chamber and the vacuum opening to the vacuum connection. This flow is driven by the vacuum supply, which is connected to the control chamber through the vacuum opening. Since, during free suction, there is initially a high flow or current density along the flow path, a vacuum is formed in the control chamber compared to the suction chamber due to the flow resistance in the throttle passage. The vacuum leads to compression of the control chamber and deformation of the flexible partition wall.

A sealing portion, in particular surrounding the throttle passage, in particular in the form of a sealing projection projecting into the interior of the control chamber, is provided on the partition wall, wherein an associated sealing seat for the sealing portion is provided within the control chamber. The sealing portion and the sealing seat are preferably arranged such that when the flexible partition wall is deformed during free suction with unoccupied at least one suction point, the sealing portion comes into contact with the sealing seat. The sealing portion and the sealing seat are preferably designed such that when the sealing projection is in contact with the sealing seat, the flow path between the suction device and the vacuum connection, in particular the flow path through the throttle passage into the control chamber, is interrupted, wherein the interruption takes place within the control chamber.

This brings the sealing projection into contact with the sealing seat and closes the valve apparatus. Since the control chamber continues to be subjected to vacuum by the vacuum supply, the vacuum present in the control chamber opposite the suction side is maintained and the valve apparatus remains closed. In this respect, the vacuum that is formed due to the flow resistance in the throttle passage when the flow along the flow path in the control chamber is sufficiently large compared to the suction chamber is used to deform the flexible partition wall. The deformation of the flexible partition wall is then used to close the valve apparatus. This achieves the desired function of an automatically closing valve.

It is particularly advantageous if the throttle passage is designed as a channel which extends through the flexible partition wall and opens into the control chamber with an outlet opening, and wherein the sealing portion and sealing seat are arranged such that when the sealing portion is in contact with the sealing seat, the outlet opening within the control chamber is closed.

The sealing projection may be formed by a bead surrounding the outlet opening.

The flexible partition wall can be designed and arranged such that it can snap bistably into a first configuration and into a second configuration, wherein in the first configuration, the sealing projection rests against the sealing seat and in the second configuration, the sealing projection is spaced apart from the sealing seat.

The extension and retraction of the lifting piston of a respective gripping unit can generally be achieved in various ways. The lifting piston is preferably pressure-actuated, in particular by compressed air, and can be transferred from the retracted configuration to the extended configuration. In this respect, the lifting piston can be adjusted along the lifting axis by applying a pressure (vacuum or overpressure) along the lifting axis.

Particularly preferred are embodiments in which the lifting piston can be displaced in the extension direction by applying compressed air, in particular can be transferred from the retracted passive configuration to the extended active configuration. In one embodiment, the suction gripper, in particular on the gripper base body, can have a compressed air connection and a compressed air distribution system for distributing compressed air to the at least one gripping unit.

Within the scope of an advantageous further development, the suction gripper can also have, in particular as part of the compressed air distribution system, a compressed air valve device which is designed to control a compressed air supply to the lifting piston, in particular to optionally control a plurality of lifting pistons independently of one another, in particular to block or release a respective flow connection between a lifting piston and the compressed air connection as required. The compressed air valve device can in particular have a separate compressed air valve for each lifting unit.

Furthermore, it may be advantageous if the suction gripper has a control device, in particular a control board, which is designed to control the compressed air valve device. The suction gripper can therefore have its own, particularly autonomous, control system. The control device can communicate, for example via a wireless connection, with a higher-level control device, for example a handling system into which the suction gripper is integrated.

The compressed air valve device and/or the control device can be arranged in or on the gripper base body. Preferably, the compressed air valve device and/or the control device are provided in the gripper base body. In this way, the suction gripper can be divided into a control assembly (compressed air valve device+optional control device) and a gripping unit assembly (gripping units). If replacement parts are required, both modules can then be replaced separately.

The at least one gripping unit can be designed such that the lifting piston is biased, in particular spring-biased, into the retracted configuration. In particular, the at least one gripping unit can be designed such that the lifting piston is automatically transferred to the retracted passive configuration when the pressure is removed, for example by the spring loading described above. In this respect, the lifting piston can be in the retracted configuration in an initial configuration.

It is also conceivable for the lifting piston to be held in the extended configuration by an applied vacuum.

The lifting piston of a gripping unit is preferably mounted in a gripping unit housing of the gripping unit. The gripping unit housing can extend longitudinally along the lifting axis, which facilitates a compact arrangement of a plurality of gripping units next to one another. The gripping unit housing can be cylindrical. The gripping unit housing can be part of the gripper base body. The gripping unit housing can be provided separately from the gripper base body and secured to the gripper base body. The gripping unit housing can be constructed in one or more parts.

Furthermore, it may be advantageous if a pressure chamber, in particular a vacuum chamber, is formed between an end of the lifting piston opposite the suction device and a housing inner wall of the gripping unit housing, so that in the active configuration an air cushion is provided behind the lifting piston, which forms a collision protection when the suction device is placed on an object. In this way, both the object and the suction device can be protected.

The lifting piston can be mounted against rotation about the lifting axis. For example, it is conceivable that an anti-rotation device could be implemented using interacting circular segments. Such an anti-rotation device is thus not clamping.

The gripper base body can be constructed in one or more parts. The gripper base body can have a securing portion for securing to a support, e.g., a flange plate of a manipulator.

The suction gripper may also comprise one or more sensors. For example, sensors can be provided to monitor a displacement position (retracted configuration/extended configuration) of the lifting piston. Alternatively or additionally, each suction device, in particular each suction point, can be assigned a sensor via which the suction device can be monitored, for example with regard to a functional status (free suction/suction with occupied suction point). For example, a pressure sensor can be provided for each suction device or each suction point to monitor the suction pressure. It is also conceivable for the speed of a handling task to be automatically adjusted by determining the holding force, depending on the vacuum prevailing in the suction gripper. Alternatively or additionally, at least one sensor can be provided for distance monitoring or collision warning. The sensors can be connected to the optional control device and can be controlled thereby.

It is conceivable that the suction gripper has only one gripping unit. Preferably, however, a plurality of gripping units is provided. It can then be advantageous if the gripping units are mounted on the gripper base body such that the lifting axes of the gripping units extend parallel to one another. In this way, a particularly compact arrangement is created, which is particularly suitable for gripping flat components such as sheet metal components.

Preferably, the lifting pistons of the gripping units can then be operated independently of one another, i.e., extended and retracted. In this respect, individual gripping units can be activated selectively.

In an advantageous further development, a plurality of the suction grippers described above can be combined to form a higher-level gripping module. The suction grippers are preferably arranged next to one another and connected to one another. For example, it is conceivable for the gripper base bodies of the suction grippers to be interlocked. The suction grippers can be controlled independently of one another. The suction grippers can be electrically connected to one another.

The advantages and optional features described above in connection with the suction gripper as such can also be used to design the gripping module.

The invention is explained in more detail below with reference to the figures. In the drawings:

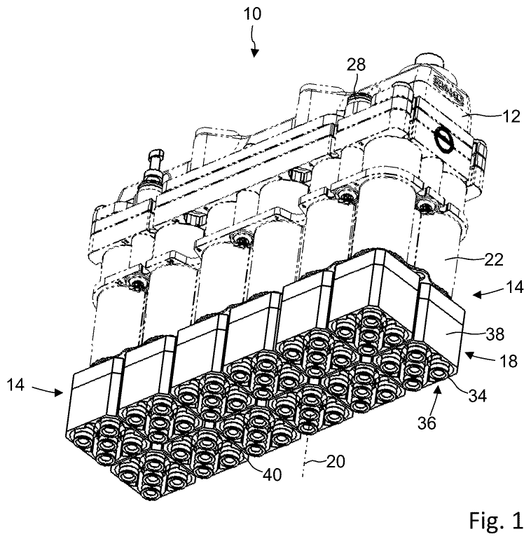

FIG. 1 shows a sketched representation of an embodiment of a suction gripper having a plurality of gripping units in a perspective view;

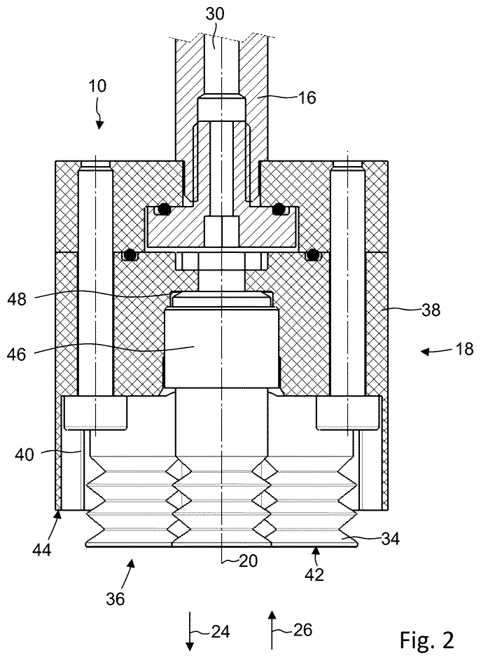

FIG. 2 shows a sketched representation of a module of a gripping unit in accordance with FIG. 1 in a sectional view;

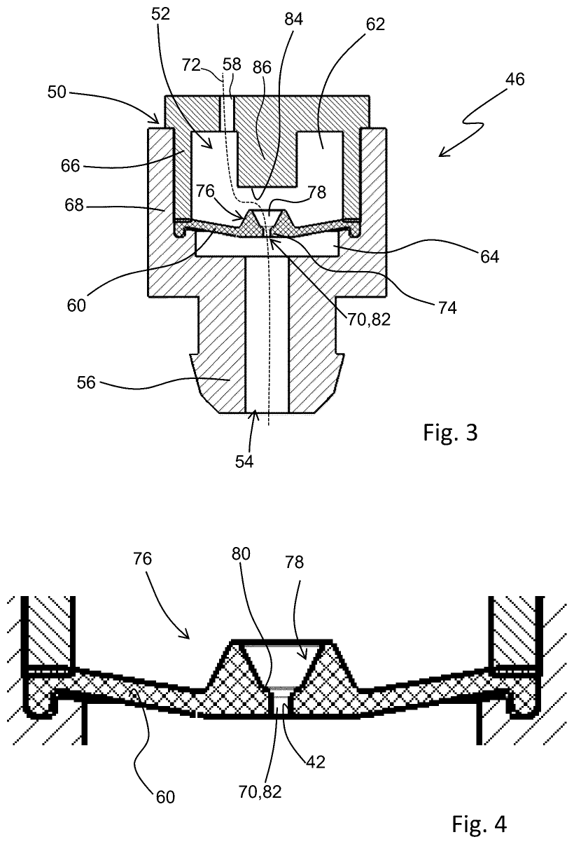

FIG. 3 shows a sketched representation of an embodiment of a valve apparatus in a sectional view;

FIG. 4 is a detailed view of the valve apparatus in accordance with FIG. 3;

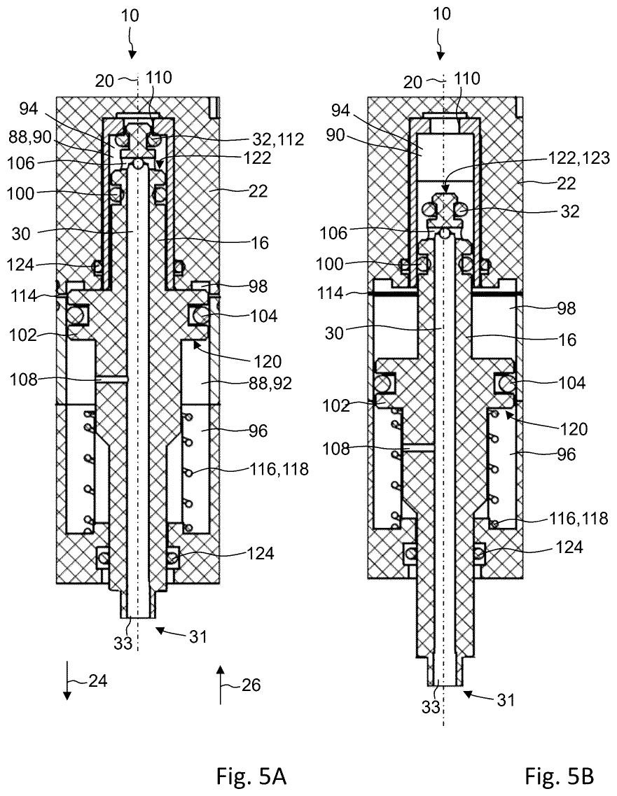

FIG. 5A, B show sketched representations of an embodiment of a lifting piston in a sectional view, with the lifting piston in a passive configuration (view A) and in an active configuration (view B);

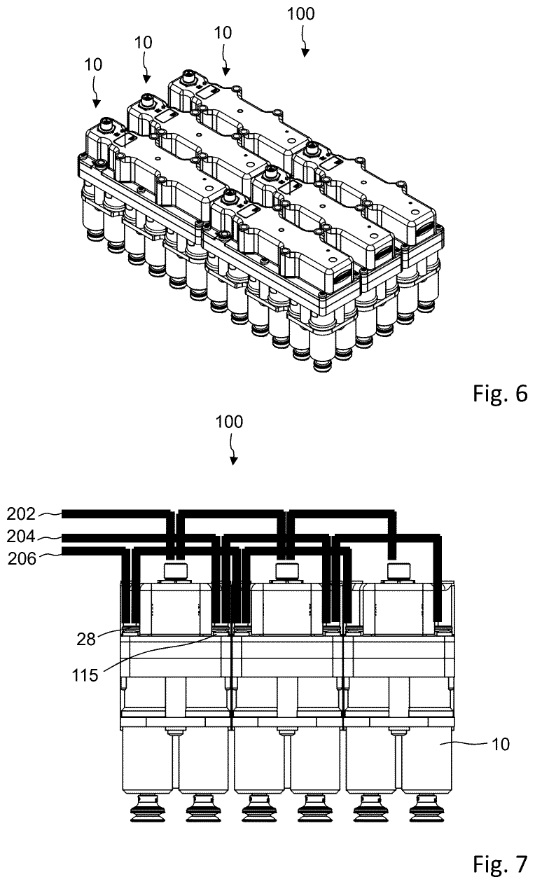

FIG. 6 shows a sketched representation of a gripping module comprising a plurality of suction grippers in a perspective view; and

FIG. 7 shows a sketched representation of the gripping module in accordance with FIG. 6 in a side view.

In the following description and in the figures, identical reference signs are in each case used for identical or corresponding features.

FIG. 1 shows an exemplary embodiment of a suction gripper, which is denoted as a whole by reference sign 10.

The suction gripper 10 comprises a gripper base body 12 and a plurality of gripping units 14 arranged thereon, twelve in the example. In embodiments not shown, more or fewer gripping units 14 may be provided.

Each gripping unit 14 comprises a lifting piston 16 (see FIG. 2, not visible in FIG. 1) and a suction device 18 which is motion-coupled to the lifting piston 16.

The lifting piston 16 is displaceable along a lifting axis 20 between an axially retracted configuration (see FIG. 5A) and an axially extended configuration (see FIG. 5B).

As explained in more detail below with reference to FIGS. 5A and 5B, the lifting piston 16 of a respective gripping unit 14 is guided displaceably in a respective gripping unit housing 22, for example, and is adjustable along the lifting axis 20 in an extension direction 24 and in a retraction direction 26 opposite to the extension direction 24.

To supply the suction devices 18 with vacuum, the suction gripper 10 also has a vacuum connection 28, which in the example is provided on the gripper base body 12. Preferably, a vacuum distribution system (not visible in the figures) is also provided in the gripper base body 12 for distributing vacuum from the vacuum connection 28 to the individual gripping units 14.

As shown in FIG. 2, each lifting piston 16 has an internal vacuum channel 30, via which the suction device 18 connected thereto can be supplied with vacuum.

As described in more detail below, a vacuum supply to the vacuum channel 30 and thus a vacuum supply to the suction device 18 is controlled via a shut-off device 32 (see FIGS. 5A and 5B, not visible in FIG. 2) such that in the retracted configuration of the lifting piston 16, a flow path between the vacuum channel 30 and the vacuum connection 28 and thus between the suction device 18 and the vacuum connection 28 is shut off (passive configuration) and in the extended configuration of the lifting piston 16, this flow path is released (active configuration).

In the exemplary configuration in accordance with FIG. 1, each suction device 18 has five suction bodies 34, each of which provides a suction point 36 for suctioning an object. The suction bodies 34 are preferably fluidly connected in parallel with the vacuum channel 30 of the lifting piston 16.

The suction bodies 34 are designed, for example, as bellows suction devices. However, the suction bodies 34 can also have any other shapes. In the illustrated embodiment, all suction bodies 34 are also identical to one another. In embodiments not shown, however, it is also conceivable for differently designed suction bodies 34, for example suction bodies 34 of different diameters, to be provided on the suction gripper 10 and/or on a respective suction device 18.

The suction devices 18 each have an optional housing 38 which is connected to the lifting piston 16 and has a suction device receiving space 40 in which the suction bodies 34 are arranged (see FIG. 2).

As can be seen from FIG. 2, the suction bodies 34, in an initial configuration in which no object is suctioned, protrude with a respective contact surface 42 along the lifting axis 20 beyond a wall 44 of the housing 38 delimiting the suction device receiving space 40.

As mentioned above, each gripping unit 14 also comprises at least one valve apparatus 46, which is designed to close automatically during free suction with unoccupied suction bodies 34 and thus to block a flow path between the suction bodies 34 and the vacuum connection 28.

In the example shown, each suction device 18 is assigned an individual such valve apparatus 46. The valve apparatus 46 is fluidly connected in series with the suction bodies 34. In this respect, the suction bodies 34 of a respective suction device 18 are assigned a common valve apparatus 46.

In embodiments not shown, however, it is also conceivable for each suction body 34 and thus each suction point 36 to be assigned its own valve apparatus 46.

In the example, the valve apparatus 46 is arranged in a flow path between the suction bodies 34 and the vacuum channel 30 of the lifting piston 16. Specifically, the valve apparatus 46 is received in a valve receiving space 48 of the housing 38 adjoining the suction device receiving space 40.

An exemplary embodiment of such a valve apparatus 46 is explained below with reference to FIGS. 3 and 4. However, the invention is not limited to such an embodiment.

As can be seen from FIG. 3, the valve apparatus 46 has a valve housing 50 which encloses a valve interior 52. The valve housing 50 has, on the one hand, a suction opening 54 which is flow-connected to the suction bodies 34. Optionally, the valve housing 50 can have a connection portion 56 by which the valve apparatus 46 can be connected to the suction device 18, in particular a suction body 34.

The valve housing 50, on the other hand, has a vacuum opening 58 which is flow-connected to the vacuum channel 30 of the lifting piston 16 and via which the valve interior 52 can thus be supplied with vacuum. In the example shown, the vacuum opening 58 is designed as a suction passage through the valve housing 50. However, the position and design of the vacuum opening 58 may vary.

The valve interior 52 is spanned by a flexible partition wall 60. The flexible partition wall 60 separates an upper control chamber 62 and a lower suction chamber 64 in the valve interior 52.

Advantageous assembly can be achieved by constructing the valve housing 50 in two parts, with an upper housing part 66 and a lower housing part 68, which can be connected to one another. In this case, the flexible partition wall 60 can be secured in the valve interior 52 by arranging the flexible partition wall 60 between the upper housing part 66 and the lower housing part 68, for example by clamping it between the two housing parts 66, 68.

The control chamber 62 is flow-connected via the vacuum opening 58 to the vacuum channel 30 of the lifting piston 16 and via this to the vacuum connection 28. In addition, the control chamber 62 is connected to the suction chamber 62 via a throttle passage 70 formed in the partition wall 60, which extends on the other side of the flexible partition wall 60.

Thus, the valve apparatus 46 creates a flow path 72, which is shown as an example in FIG. 3. The flow path 72 extends from the suction opening 54, through the suction chamber 64, further through the throttle passage 70 into the control chamber 62 and at least partially through the control chamber 62, and finally out of the control chamber 62 through the vacuum opening 58.

The throttle passage 70 defines a constriction 74 along the flow path 72 (FIGS. 3 and 4). As a result, the throttle passage 70 presents a flow resistance for flows from the suction chamber 64 into the control chamber 62.

The flexible partition wall 60 has a sealing projection 76 which projects into the control chamber 62. In the example, the sealing projection 76 has a trough 78 which is preferably conical or funnel-shaped. An outlet opening 80 of the throttle passage 70 opens into a trough bottom of the trough 78. In the example shown, the throttle passage 70 is designed as a channel 82 which extends through the flexible partition wall 60 (shown in detail in FIG. 4).

In the control chamber 62, a sealing seat 50 is also provided, against which the sealing projection 76 can be brought into contact when the flexible partition wall 60 is deformed. In the example shown, the sealing seat 84 is formed by a portion 86 of the valve housing 50 protruding into the control chamber 62.

In the case of free suction, i.e., when the shut-off device 32 is open and the suction points 36 are unoccupied, a comparatively strong flow from the suction opening 54, through the suction chamber 64 and through the throttle passage 70 into the control chamber 62 occurs due to the vacuum present at the vacuum opening 58. The flow along the flow path 72 then continues through the vacuum opening 58 to the vacuum channel 30 in the lifting piston 16 and finally to the vacuum connection 28. Due to the flow resistance in the throttle passage 70, a vacuum is formed in the control chamber 62 compared to the suction chamber 64. This causes the flexible partition wall 60 to deform such that the volume of the control chamber 62 is reduced. As a result, the sealing projection 76 moves towards the sealing seat 84 and comes into contact with it. This results in the flow path 72 being closed. Since the control chamber 62 continues to be supplied with vacuum via the vacuum opening 58, the sealing projection 76 then remains in the position in which it rests against the sealing seat 84 (closing configuration of the valve apparatus). In contrast, when the release configuration shown in FIG. 3 is present, the sealing projection 76 is spaced apart from the sealing seat 84.

As indicated in FIG. 3, the flexible partition wall 60 is preferably formed integrally with the sealing projection 76, for example from a homogeneous, flexible material (plastics or rubber). In embodiments not shown, the sealing projection 76 can, however, also be provided, for example, by a sealing element provided separately from the partition wall 60 and then connected to the partition wall 60.

An exemplary embodiment of a lifting piston is explained below with reference to FIGS. 5A and 5B. However, the invention is not limited to such an embodiment.

As can be seen from FIG. 5A, the lifting piston 16 is displaceably mounted in the gripping unit housing 22 mentioned above. The gripping unit housing preferably extends longitudinally along the lifting axis 20 and delimits a housing interior 88 in which the lifting piston 16 is at least partially received. In the specific example, the housing interior 88 has a first housing interior portion 90 and a second housing interior portion 92 arranged behind it in the extension direction 24. By way of example and preferably, a cross-sectional area of the first housing interior portion 90, viewed along the lifting axis 20, is smaller than a cross-sectional area of the second housing interior portion 94.

As shown in FIG. 5A, the lifting piston 16 is designed such that the housing interior 88 is divided into a first vacuum chamber 94, a second vacuum chamber 96 and an overpressure chamber 98 arranged between the first vacuum chamber 94 and the second vacuum chamber 96. As can be seen from a comparison of FIGS. 5A and 5B, the chambers 94, 96, 98 can be changed in size by changing a displacement position of the lifting piston 16 along the lifting axis 20.

In the specific example, the lifting piston 16 separates, by a first sealing device 100, a region of the first housing interior portion 90, which forms the first vacuum chamber 94.

In the second housing interior portion 92, the lifting piston 16 has a radial projection 102 which divides the second housing interior portion 92 into the overpressure chamber 98 and the second vacuum chamber 96. A second sealing device 104 is provided to seal the overpressure chamber 98 from the second vacuum chamber 96. For example, the second sealing device 104 is designed in the form of an O-ring, which is arranged in a groove in the radial projection 102.

The first vacuum chamber 94 is flow-connected to the second vacuum chamber 96 via the above-mentioned vacuum channel 30 in the lifting piston 16, so that the second vacuum chamber 96 can be supplied with vacuum via the first vacuum chamber 94. In particular, the same pressure always prevails in the first vacuum chamber 94 and in the second vacuum chamber 96. Specifically, the vacuum channel 30 has a supply opening 106 which opens into the first vacuum chamber 94 and a, for example radial, vacuum opening 108 which opens into the second vacuum chamber 96. The vacuum guide 30 can thus bridge the overpressure chamber 98.

The vacuum channel 30 opens at the free end 31 of the lifting piston 16 with a suction opening 33, via which the suction device 18 arranged at the free end 31 of the lifting piston 16 can be supplied with vacuum.

As clearly shown in FIG. 5B, the first vacuum chamber 94 has a chamber opening 110 which is flow-connected to the vacuum connection 28 and via which the first vacuum chamber 94 and thus also the second vacuum chamber 96 and the suction device 18 can be supplied with vacuum.

The lifting piston 16 has a third sealing device 112 at its axial end facing away from the suction device 18, which is designed to seal the chamber opening 110 in the passive configuration and thus to prevent a vacuum supply to the vacuum chambers 94, 96 and the suction device 18 (see FIG. 5A).

By displacing the lifting piston 16 in the extension direction 24 (see FIG. 5B), the third sealing device 112 is lifted from the chamber opening 110 so that vacuum can flow into the first vacuum chamber 94 and from there via the vacuum channel 30 into the second vacuum chamber 96 and the suction device 18.

The third sealing device 112 thus forms a shut-off device 32 as mentioned above.

As only schematically indicated in FIG. 5A, the gripping unit housing 22 in the example also comprises an optional compressed air opening 114, via which the overpressure chamber 98 can be supplied with compressed air. The compressed air opening 114 can be flow-connected to a compressed air connection 115 (see FIG. 7) of the suction gripper 10, in particular via a compressed air distribution system not shown in detail. As mentioned above, the compressed air distribution system may comprise a compressed air valve device for controlling a compressed air supply to the gripping units 14.

If the overpressure chamber 98 is pressurized with compressed air, the compressed air acts on the lifting piston 16, in particular the radial projection 102, so that a force acting in the extension direction 24 is exerted on the lifting piston 16 and the lifting piston 16 is thus moved in the extension direction 24.

The suction gripper 10 also comprises an optional spring device 116, which is designed to urge the lifting piston 16 into the passive configuration (see FIG. 5A). The spring device 116 comprises, for example, a compression spring 118, which is only partially shown in the figures. In the example, the compression spring 118 is arranged in the second vacuum chamber 92 and is supported with a first end on an inner wall of the housing 22. The second end of the compression spring 118 is supported on the radial projection 102 (for the sake of clarity, only a partial section of the spring 118 is shown in the figures).

In the passive configuration (initial configuration) shown in FIG. 5A, the lifting piston 16 is biased by the spring 118 in the retraction direction 26 such that the lifting piston 16, with the third sealing device 112, rests against the housing 22 in a sealing manner at the chamber opening 110. In this configuration, a vacuum supply is prevented. If the overpressure chamber 98 is now at least briefly subjected to overpressure such that the lifting piston 16 moves in the extension direction 24 against the spring loading, the chamber opening 110 is opened so that vacuum is passed into the first vacuum chamber 94 and subsequently via the vacuum channel 30 into the second vacuum chamber 96 and the suction device 18.

The vacuum chambers 94, 96 and the lifting piston 16 are preferably dimensioned such that the vacuum then present in the vacuum chambers 94, 96 exerts a force acting in the extension direction 24 on the lifting piston 16.

In the example, this is achieved in that the lifting piston has first surface portions 120 which are oriented such that a force acting on the lifting piston 16 in the extension direction 24 is exerted on the first surface portions 120 by the vacuum prevailing in the vacuum chambers 94, 96. In the example, such first surface portions 120 are formed, for example, by the axial end faces of the radial projection 102, which delimit the second vacuum chamber 96.

In addition, second surface portions 122 are provided which are oriented such that the vacuum prevailing in the vacuum chambers 94, 96 acts on the second surface portions 122, exerting a force acting on the lifting piston 16 in the retraction direction 24. In the example, such second surface portions 122 are formed, for example, by the axial end face 123 of the lifting piston 16, which delimit the first vacuum chamber 94.

A sum of all first surface portions 120 is greater than a sum of all second surface portions 122, so that a net force acts in the extension direction 24. This force is superimposed on a force resulting from the application of compressed air.

In order to prevent vacuum leakage, optional additional sealing devices 124 are provided in the example, which seal the lifting piston 16 from the housing 22.

As mentioned above, it is also conceivable that a plurality of the suction grippers 10 described above are combined to form a higher-level gripping module. An exemplary embodiment of such a gripping module is shown in FIG. 6 and is denoted by reference sign 200. As can be seen from FIG. 6, the suction grippers 10 are arranged next to one another such that the lifting axes 20 extend parallel to one another and in particular a flat suction surface is formed. The gripper base bodies 12 of the suction grippers 10 are preferably mechanically connected to one another.

As schematically shown in FIG. 7, the suction grippers 10 of the gripping module 100 can also be fluidly and/or electrically connected to one another, for example via an electrical supply line 202, a compressed air supply line 204 and/or a vacuum supply line 206.

1. A suction gripper for suctioning and handling an object, the suction gripper comprising
a gripper base body,
a vacuum connection for connection to a vacuum supply,
at least one gripping unit mounted on the gripper base body, the at least one gripping unit including a lifting piston and a suction device which is motion-coupled to the lifting piston and has at least one suction point or a suction body, for suctioning an object to be gripped, wherein
the suction device can be supplied with vacuum through the lifting piston,
the lifting piston is adjustable along a lifting axis between an axially retracted passive configuration and an axially extended active configuration,
the gripping unit has a shut-off device for shutting off and releasing a flow path between the vacuum connection and the suction device, the shut-off device being designed such that the shut-off device blocks the flow path in the passive configuration of the lifting piston and releases the flow path in the active configuration of the lifting piston, and
the gripping unit has at least one valve apparatus which is arranged in a flow path between the at least one suction point and the vacuum connection and which is designed to close automatically in the event of free suction with unoccupied at least one suction point and to delimit the flow path between the at least one suction point and the vacuum connection.

2. The suction gripper according to claim 1, wherein the at least one valve apparatus is arranged in a flow path between the at least one suction point, or the suction device, and the lifting piston.

3. The suction gripper according to claim 1, wherein the suction device has a plurality of suction points or suction bodies.

4. The suction gripper according to claim 1, wherein at least a subset of the suction points of the suction device or the suction points of the suction device, is/are assigned a common valve apparatus.

5. The suction gripper according to claim 1, wherein each suction point or each suction body, of the suction device is assigned a separate valve apparatus.

6. The suction gripper according to claim 1, wherein the suction device has at least one suction body which provides a suction point, wherein the suction device has a housing which is mounted on the lifting piston, wherein the housing has, on a side facing away from the lifting piston, a suction device receiving space for the at least one suction body, wherein the housing has a valve receiving space, arranged between the suction device receiving space and the lifting piston, in which the at least one valve apparatus is arranged.

7. The suction gripper according to claim 1, wherein the valve apparatus has a valve housing having a valve interior in which a sealing portion and a sealing seat are arranged, wherein the sealing portion and the sealing seat are designed such that when the sealing portion rests against the sealing seat, the flow path between the at least one suction point and the vacuum connection is interrupted, wherein the sealing section is displaceable in the valve housing such that the sealing section is transferred into contact with the sealing seat by the resulting suction air flow during free suction with unoccupied at least one suction point.

8. The suction gripper according to claim 1, the valve apparatus includes:
a valve housing which encloses a valve interior and which has a vacuum opening flow-connected to the vacuum connection and a suction opening flow-connected to the at least one suction point,
a flexible partition wall which extends in the valve interior such that, the flexible partition wall defines a control chamber in the valve interior, and, the flexible partition wall defines a suction chamber in the valve interior, wherein the control chamber is flow-connected to the vacuum opening and the suction chamber is flow-connected to the suction opening,
wherein the flexible partition wall has a throttle passage such that a flow path is provided from the suction opening through the throttle passage into the control chamber and further from the control chamber through the vacuum opening,
wherein the throttle passage is designed such that a flow resistance for flows through the throttle passage is defined such that, in the case of free suction with unoccupied at least one suction point, a vacuum is formed in the control chamber compared to the suction chamber due to the flow resistance through the throttle passage,
wherein the flexible partition wall is designed such that the flexible partition wall is deformable due to the vacuum that is formed in the control chamber during free suction, wherein a sealing portion, surrounding the throttle passage is provided on the partition wall, and
wherein an associated sealing seat for the sealing portion is provided within the control chamber, wherein the sealing section and the sealing seat are arranged such that when the flexible partition wall is deformed during free suction with unoccupied at least one suction point, the sealing portion comes into contact with the sealing seat such that the flow path between the suction opening and the vacuum opening within the control chamber is interrupted.

9. The suction gripper according to claim 8, wherein the throttle passage is designed as a channel which extends through the flexible partition wall and opens into the control chamber with an outlet opening, and wherein the sealing portion and sealing seat are arranged such that when the sealing portion is in contact with the sealing seat, the outlet opening within the control chamber is closed.

10. The suction gripper according to claim 1, wherein the lifting piston can be transferred from the passive configuration to the active configuration by compressed air, wherein the suction gripper has a compressed air connection and a compressed air distribution system for directing the compressed air to the at least one gripping unit, wherein the suction gripper also has a compressed air valve device, integrated into the gripper base body, which is designed to block or release a respective flow connection between the compressed air connection and the at least one lifting piston, independently of one another.

11. The suction gripper according to claim 10, wherein a control device, in particular or a control board, is provided in or on the gripper base body, which is designed to control the compressed air valve device.

12. The suction gripper according to claim 1, wherein the lifting piston is biased into the passive configuration, in particular or spring-biased.

13. The suction gripper according to claim 1, wherein a plurality of gripping units is provided, wherein the gripping units are mounted on the gripper base body such that the lifting axes of the gripping units extend parallel to one another.

14. A gripping module comprising a plurality of suction grippers according to claim 1, wherein the plurality of suction grippers are connected to one another.
